(19) United States
(12) Patent Application Publication
(10) Pub. No.: US 2010/0182794 A1
(43) Pub. Date: Jul. 22, 2010

(54) Spot light

(76) Inventor: Hua-Jung Chiu, Jhongli City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/320,082

(22) Filed: Jan. 16, 2009

(51) Int. Cl. F21V 29/00; F21V 15/01

(52) U.S. Cl. 362/373; 362/362

(57) ABSTRACT

A spot light comprises a housing, a connecting rod and a slidable unit. One end of the connecting rod is pivotingly connected to the housing so that the housing can be rotated in a predetermined angle. The other end of the connecting rod is pivotingly connected to the slidable unit. Moreover, the housing includes a case, the first and the second plates for receiving the light source and the electronic device. As above-mentioned, the spot light has an integral casing unit and the time and cost of assembling the spot light are reduced.

### BACKGROUND OF THE INVENTION

1. Field of the Invention

The present invention relates to a spot light and in particular to a spot light with an integral casing for receiving the light source.

2. Description of Related Art

Artificial light sources such as lamps are most common today in the form of electric lights, gas lighting, candles, or oil lamps in certain situations for illuminating the interior of buildings. Lighting fixtures come in a wide variety of styles for various functions and are classified by intended use as general, localized, or decorating lighting, depending on the distribution of the light. Proper lighting can enhance task performance or aesthetics. For example, downlighting is most common; with fixtures on the ceiling casting downward so as to projecting light downwards. Downlighting tends to be the most common lighting type, used in both offices and homes because the lighting system is easy to design and to assemble. Indirect uplighting uses a diffuse surface to reflect light in a space and can minimize disabling glare in the space. Uplighting systems provide more uniform lighting. However, indirect lighting is completely reliant upon the reflectance value of the surface and has the problem of excessive energy consumption due to the indirect illumination.

Light sources can be incandescent, fluorescent, HID (high intensity discharge) or LED. For associating with the application, the light source can be designed into many types of lighting systems. Lighting design requires consideration of the amount of functional light provided, the energy consumed, as well as the aesthetic impact supplied by the lighting system. Therefore, it is important that the light production and luminaire photometric are balanced with the artistic application of light as a medium in our indoor environment.

Monorail lighting (track lighting) systems are popular for spot illumination because they are much easier to install than recessed lighting, and individual fixtures of the monorail lighting system are decorative and can be easily fixed at a wall. The monorail lighting system has regained some popularity recently in low-voltage tracks because they do not have the safety issues with lower line-voltage systems. There are traditional spots and floods, as well as other small hanging fixtures. A modified version of this is cable lighting, where lights are hung from or clipped to bare metal cables under tension. Monorail lighting system is widely used indoor such as office, home or some buildings. In other words, a monorail lighting system is a rail-based lighting system based on a single rail, which acts as a sole support and guide track for the lighting unit.

However, the traditional monorail lighting system has many structural parts for receiving light source, electronic devices, and so on. Thus, it spends much time for assembling the traditional monorail lighting system. Moreover, it is necessary for manufacturing the structures with high tolerance so that they can be assembled to form a precise housing.

Therefore, in view of this, the inventor proposes the present invention to overcome the above problems based on his expert experience and deliberate research.

### SUMMARY OF THE INVENTION

The primary object of the present invention is provided for a spot light. The spot light has an integral housing and the manufacturing cost of the single housing can be reduced.

Another object of the present invention is provided for a spot light which has modified structure and the heat dissipating efficiency of the spot light is improved.

In order to achieve the above objects, the present invention provides a spot light. The spot light comprises a housing, a connecting rod and a slidable unit. One end of the connecting rod is pivotingly connected to the housing so that the housing can be rotated in a predetermined angle. The other end of the connecting rod is pivotingly connected to the slidable unit. Moreover, the housing includes a case, the first and the second plates for receiving the light source and the electronic device.

Depending on the present invention, the spot light is provided for emitting light on the rails of the monorail lighting system. The housing is integrally formed so that the aspect of the spot light is attractive and the cost for assembling the housing is reduced.

In order to better understand the characteristics and technical contents of the present invention, a detailed description thereof will be made with reference to the accompanying drawings. However, it should be understood that the drawings and the description are illustrative but not used to limit the scope of the present invention.

### BRIEF DESCRIPTION OF THE DRAWINGS

FIG. 1 is a schematic view showing spot light according to the present invention.

FIG. 2 is an exploded drawing showing the first embodiment of the spot light according to the present invention.

FIG. 3 is a top view showing the first embodiment of the spot light according to the present invention.

FIG. 4 is an exploded drawing showing the second embodiment of the spot light according to the present invention.

FIG. 5 is a top view showing the second embodiment of the spot light according to the present invention.

### DETAILED DESCRIPTION OF PREFERRED EMBODIMENTS

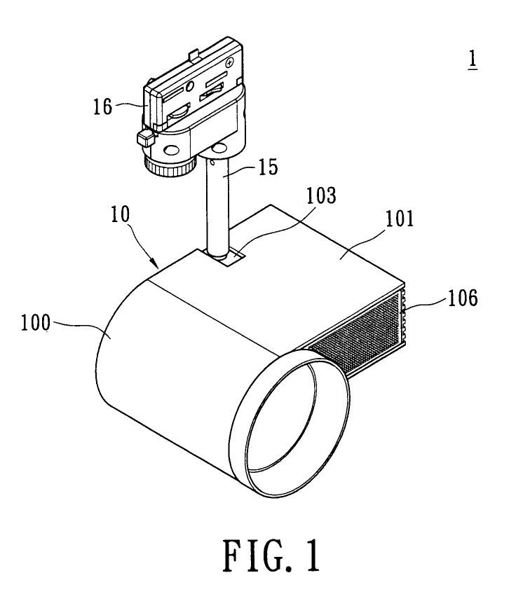

Please refer to FIG. 1; the invention discloses a housing 10 for a spot light 1. Monorail lighting (so-called track lighting) is a single-circuit, and two-conductor rail lighting system. In general, light fixtures of the monorail lighting system are attached anywhere on a continuous track device which contains electrical conductors. Tracks of the lighting fixture can be mounted to ceilings or walls, lengthwise down beams, or crosswise across rafters or joists. They can also be hung with rods from especially high places like vaulted ceilings. There are several different types of track. Some are very flexible and can be curved in any shape or form and some are more rigid and can be curved very slightly. Some patterns that can be made are “S curves” or “spirals”. A master transformer feeds all of the fixtures on the track or rod with 12 or 24 volts, instead of each light fixture having its own line-to-low voltage transformer. The rail may be cut in the field to custom lengths, and sections may be joined to each other using couplers to provide longer single-circuit runs. The present invention provides a housing 10 slidably disposed on the rail for a wide range of lighting applications. The housing 10 includes a casing 100, a first plate 101 and a second plate 102. The first plate 101 and the second plate 102 extend from the casing 100 and the first and the second plate 101, 102 are preferably parallel to each other. The casing 100 is generally cylindrical, and a first receiving room 101 is defined inside the casing 100 for accommodating light source 14. Furthermore, the casing 100 has two openings on two ends thereof. The casing 100, the first plate 101 and the second plate 102 are formed integrally and are made of aluminium. For example, the casing 100, the first plate 101 and the second plate 102 are formed by aluminium extrusion. Extrusion is a process used to create objects of a fixed cross-sectional profile. Therefore, the casing 100, the first plate 101 and the second plate 102 essentially have the same cross-section from the light projecting end to the opposite end of the spot light 1. Aluminum is pushed or drawn through a die or mold of the desired cross-section. The one main advantage of the extrusion process over other manufacturing processes is the ability to create very complex cross-sections. It also forms finished parts with an excellent finishing and smooth surface. Accordingly, aluminum with high heat conductivity is formed into the casing 100, the first plate 101 and the second plate 102 by extrusion.

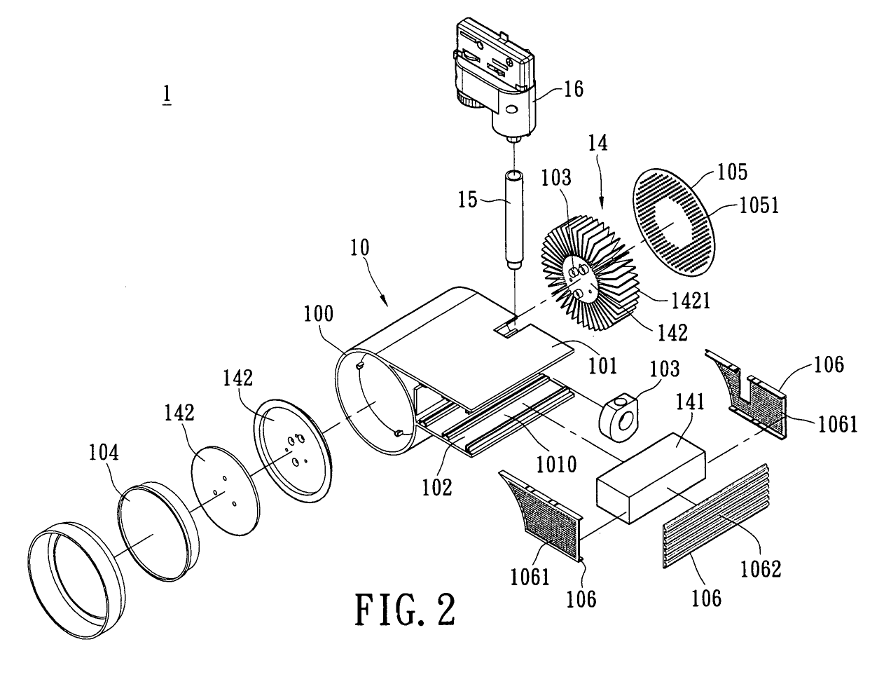

The first plate 101 and the second plate 102 extends in the same direction so that the first plate 101, the second plate 102, and a least one auxiliary plate 106 can be constructed as an enclosure. Please refer to FIG. 2; three auxiliary plates 106 are assembled with the first plate 101 and the second plate 102 so as to form as an enclosure. The three auxiliary plates 106 respectively cover front, back and side openings of the first plate 101 and the second plate 102 in order to define a second receiving room 1010 for accommodating an electronic device 141 for driving the light source 14 inside the casing 100. However, the three individual auxiliary plates 106 can be formed as a collective auxiliary plate depending on the manufacturing method. Accordingly, the first plate 101, the second plate 102 and the auxiliary plate 106 are constructed as a single casing unit for the application of a monorail lighting system and the above-mentioned casing unit can provide an optimized structure for the monorail lighting system.

Furthermore, the spot light 1 further has a connecting rod 15 and a slidable unit 16. The slidable unit 16 is slidably connected to the rail tracks of the monorail lighting system and the slidable unit 16 is provided for transmitting power to the light source 14. The connecting rod 15 is disposed between the slidable unit 16 and the single casing unit (i.e., the first plate 101, the second plate 102 and the auxiliary plate 106). One end of the connecting rod 15 is pivotingly connected to the slidable unit 16, and the other end of the connecting rod 15 is pivotingly connected to single casing unit so that the single casing unit can rotate vertically and horizontally for projecting the light. In other words, the single casing unit can be pivotingly rotated for emitting upward, downward light or light in another direction.

FIGS. 1-2 show the first embodiment of the present invention. The housing 10 can be applied for an LED monorail lighting system. The light source 14 includes a base 142 and at least one LED 143 disposed on the base 142. In the embodiment, the base 142 is constructed by three parts (all parts are numerically referenced by 142) for supporting the LEDs 143 and the base 142 and the LEDs 143 are received inside the casing 100. Moreover, the base 142 has a plurality of heat sinks 1421 on the side thereof for dissipating heat from LEDs 143. Therefore, the base 142 and the LEDs 143 are accommodated inside the casing 100 and the electronic device 141, for example a LED driver, is accommodated in the second receiving room 1010 next to the first receiving room 101. The LED driver is electrically connected with the LEDs 143. On the other hand, there is a pivoting element 103 disposed on the first plate 101 (i.e. in the second receiving room 1010) and the connecting rod 15 is connected to the pivoting element 103 for rotating the single casing unit.

Furthermore, there is a transparent cover 104 disposed on one end of the casing 100 for transmitting the light emitted from the LEDs 143. A bottom cover 105 is disposed on the other end of the casing 100 for sealing the casing. The bottom cover 105 has some holes 1051 for dissipating heat by air flow. For the reason of dissipating the heat generated by the electronic device 141, the auxiliary plates 106 can have heat-dissipating structures thereon, such as venting holes 1061 and heat sinks 1062. However, the heat-dissipating structures can be modified by any similar structures and they can be selectively formed on the auxiliary plates 106.

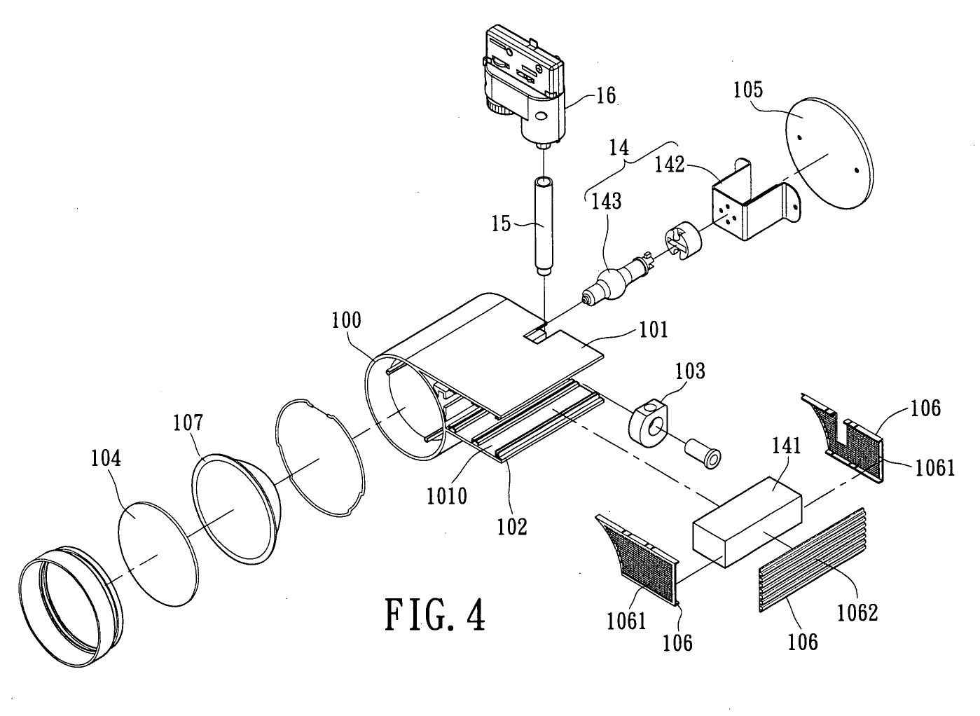

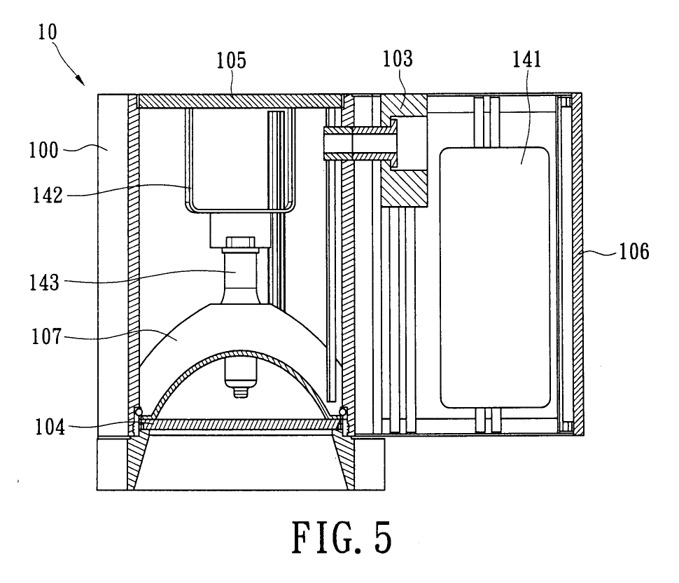

Please refer to FIGS. 4 to 5 showing the second embodiment thereof. In this embodiment, the housing 10 is used in a HID (High Intensity Discharge Lamps) monorail lighting system. The light source 14 includes a base 142 and at least one HID 143′ disposed on the base 142. The HID 143′ can be metal halide lamp, high-pressure sodium lamps, or mercury vapor lamps. In the embodiment, the base 142 is constructed into frame structure for supporting the HID 143′. Similarly, the housing 10 includes a casing 100, a first plate 101 and a second plate 102 and they are formed integrally and they are made of aluminium. The base 142 and the HID 143′ are accommodated inside the casing 100. The reflective cap 107 is also received inside the casing 100 and corresponds to the HID 143′. Furthermore, there is a transparent cover 104 disposed on one end of the casing 100 for transmitting the light emitted from the HID 143′. A bottom cover 105 is disposed on the other end of the casing 100 for sealing the casing 100.

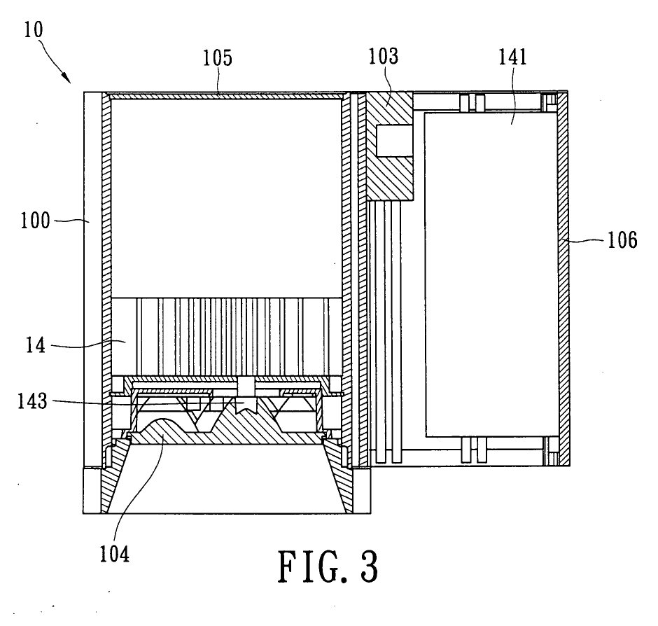

The first plate 101, the second plate 102, and a least one auxiliary plate 106 can be constructed as an enclosure. As shown in FIG. 3, three auxiliary plates 106 are assembled with the first plate 101 and the second plate 102 so as to define a second receiving room 1010 for accommodating an electronic device 141 for driving the light source 14. In this embodiment, the electronic device 141 is ballast for HID and there are some venting holes 1061 and heat sinks 1062 disposed on the auxiliary plates 106 for dissipating heat generated by the ballast for HID.

The spot light 1 further has a connecting rod 15 which connects to the housing 10. In particular, there is a pivoting element 103 disposed on the first plate 101 (i.e. inside the second receiving room 1010), and the connecting rod 15 is connected to the pivoting element 103 for rotating the housing 10. The slidable unit 16 is slidably connected to the rail tracks of the monorail lighting system and the slidable unit 16 is provided for transmitting power to the light source 14.

Accordingly, when the spot light 1 is assembled, the casing 100, the first plate 101 and the second plate 102 are constructed as a single light apparatus, and the spot light 1 can be easily used on the rail tracks of the monorail lighting system.

To sum up, the present invention has the following advantages:
1. The spot light 1 has single and integral housing so that the cost of assembling the monorail lighting system is reduced. Moreover, the electronic device can be hidden inside the second receiving room so that the aspect of the spot light 1 is attractive.
2. The casing 100, the first plate 101 and the second plate 102 are formed integrally by extrusion of aluminum so that the heat dissipating efficiency is improved. Furthermore, the light source and the electronic device are respectively accommodated in the casing 1 00 and the receiving room defined by the first and second plates 101, 102 so that the light source and the electronic device will not influence each other by the heat they generate. In other words, heat degeneration of the light source is reduced.

Although the present invention has been described with reference to the foregoing preferred embodiment, it will be understood that the invention is not limited to the details thereof. Various equivalent variations and modifications may occur to those skilled in this art in view of the teachings of the present invention. Thus, all such variations and equivalent modifications are also embraced within the scope of the invention as defined in the appended claims.

What is claimed is:

1. A spot light, comprising:
a housing, comprising:
a casing defining a first receiving room for accommodating a light source;
a first plate and a second plate extending from the casing; and
a least one auxiliary plate assembled with the first and the second plates to form a second receiving room for accommodating an electronic device;
a connecting rod pivotably connected on the housing; and
a slidable unit connecting with the connecting rod;
wherein the slidable unit is slidably disposed on tracks of the monorail lighting.

2. The spot light according to claim 1, wherein the casing has a cylindrical shape, and two openings are defined at two ends of the casing.

3. The spot light according to claim 1, wherein the auxiliary plates are assembled with the first and the second plates to form an enclosure.

4. The spot light according to claim 1, wherein the auxiliary plates have heat-dissipating structures thereon.

5. The spot light according to claim 1, wherein the heat-dissipating structures are venting holes or heat sinks.

6. The spot light according to claim 1, wherein the housing further has a pivoting element thereon and the connecting rod is connected to the pivoting element.

7. The spot light according to claim 1, wherein the light source includes a base and at least one LED (light emitting diode) disposed on the base.

8. The spot light according to claim 7, wherein a plurality of heat sinks are fitted around the base.

9. The spot light according to claim 1, wherein the light source includes a base and one HID (high intensity discharge lamps) disposed on the base.

10. The spot light according to claim 9, further comprising a reflective cap received in the casing.

11. The spot light according to claim 1, further comprising a transparent cover disposed on one end of the casing.

12. The spot light according to claim 11, further comprising a bottom cover disposed on the other end of the casing.
